(19) United States
(12) Patent Application Publication
(10) Pub. No.: US 2005/0169737 A1
(43) Pub. Date: Aug. 4, 2005

(54) Detachable platform for trailer

(76) Inventor: Huichun Yan, Shanghai (CN)

Correspondence Address: ARTHUR KING MA, 1030 CORONADO DRIVE, ARCADIA, CA, 91007, US

(21) Appl. No.: 10/779,006

(22) Filed: Feb. 13, 2004

(30) Foreign Application Priority Data
Dec. 11, 2003 (CN) 200310122537.7

(51) Int. Cl. B60P 1/64

(52) U.S. Cl. 414/498

(57) ABSTRACT

A detachable platform for detachable mounting in a trailer includes a frame assembly and at least two support assemblies mounted thereon. Each support assembly includes a transverse member, two moveable members, and two support legs attached to the moveable members. Each support leg has a screw rod having a non-threaded portion and a threaded portion, a gear secured to the screw rod, an upper portion rotatably engaged with the non-threaded portion of the screw rod, a lower portion threadedly engaged with the threaded portion, and gear driving means for driving the gear and the screw rod to rotate such that the lower portion is operable between the first extended position whereat the frame assembly is capable of being raised and supported on the ground by means of the support legs and a second retracted position whereat the frame assembly is capable of being self-supported by wheels of the trailer.

### BACKGROUND OF THE PRESENT INVENTION

1. Field of the Present Invention

This invention relates to platforms for cargo containers and the like. More specifically, the invention relates to a platform detachably mounted on a truck body or trailer, and having retractable legs to independently stand on the ground.

2. Description of Related Arts

FIGS. 1 and 2 shows a conventional truck comprising a tractor 1 and a trailer 2 attached to the tractor 1. A cargo container 3 is generally shipped on the trailer 2 from one point, such as a container center, to a required destination. When the trailer 2 and the container 3 carried thereon reach the required destination, the trailer 2 and the container 3 generally remain together during discharge of cargo. Thus, it generally takes some time to unload the container; the trailer has to remain merely in situ as a platform to support the container 3. Such use is uneconomical and there is a need for a way of separating the trailer 2 from the container 3 during discharge of cargo.

In the past, attempts have been made to make a separate detachable platform which supports containers. For instance, U.S. Pat. No. 4,522,550 discloses a detachable platform for supporting a container. The detachable platform has extensible legs to independently stand on the ground and permits a truck body or a trailer to pass beneath the detachable platform between the extensible legs and has a built-in jacking system that raises the platform off the truck body or the trailer to allow the extensible legs to be extended. Each extensible leg includes a horizontal tubular member and a side extension portion rotatably slidably engaged in an end of the horizontal member. The horizontal member and the side extension portion are coupled with pins. A vertical fixed member is rigidly attached to an end of the extension portion. A telescopic extension member is slidably engaged in the vertical fixed member and is locked to the vertical fixed member with pins. However, after repeated use, the pins that are used to couple the horizontal member and the side extension portion, and the pins that are used to couple the telescopic extension and the vertical fixed member tend to be worn out and damaged. This poses potential hazardous risks, such as rollovers of the detachable platform and the container. In addition, due to the complex structure and the configuration of the extensible legs, the process for deploying and retracting the extensible legs is actually cumbersome and time-consuming.

### SUMMARY OF THE PRESENT INVENTION

In view of the above, an object of the present invention is to provide a simple maneuverable platform which is detachable from a trailer and is capable of being self-supported.

In one aspect of the invention, there is provided a detachable platform for supporting a container. The detachable platform is adapted for detachable mounting in a trailer. The detachable platform includes a substantially flat frame assembly having at least two longitudinal beams and at least two support assemblies spacedly mounted on the frame assembly for supporting the frame assembly. Each support assembly includes a transverse channel member secured to the longitudinal beams, two horizontal moveable members movably engaged in opposite ends of the transverse channel member and moveable between a retracted position and an extended position whereat the trailer is allowed to pass between support legs, and two support legs attached to the horizontal moveable members.

Each support leg includes a screw rod having a non-threaded portion and a threaded portion, a gear coaxially fixedly secured to the screw rod, an upper portion rotatably engaged with the non-threaded portion of the screw rod, a lower portion having a support pad at the base thereof threadedly engaged with the threaded portion of the screw rod, the lower portion being reciprocally moveable relative to the upper portion between a first extended position whereat the frame assembly is capable of being raised and being self-supported on the ground by means of the support legs, and a second retracted position whereat the frame assembly is capable of being supported by wheels of the trailer, and gear driving means for driving the gear and the screw rod to rotate such that the lower portion is operable between the first and second position.

In another aspect of the invention, there is provided another detachable platform for supporting a container. The detachable platform is adapted for detachable mounting in a trailer. The detachable platform includes a substantially flat frame assembly having at least two longitudinal beams; and at least two support assemblies spacedly mounted on the frame assembly for supporting the frame assembly. Each support assembly includes a transverse channel member mounted to the longitudinal beams, two horizontal moveable members movably engaged in opposite ends of the transverse channel member and moveable between a retracted position and an extended position whereat the trailer is allowed to pass between support legs, and two support legs attached to the horizontal moveable members.

Each support leg includes an upper portion having a rotatable member with a gear fixedly to the rotatable member and an inner threaded hole defined in the rotatable member, a first screw rod, a second screw rod and gear driving means. The rotatable member defines an inner threaded hole therein and an outer thread on an outer surface thereof. The rotatable member is rotatable relative to the upper portion. The first screw rod has an inner threaded hole defined therein and an outer thread. The first screw rod is threadedly engaged in the inner threaded hole of the rotatable member and is moveable relative to the rotatable member between a first position whereat the horizontal moveable member is located adjacent to an upper end of the first screw rod and a second position whereat the horizontal moveable member is located adjacent to a lower end of the first screw rod. The second screw rod is threadedly engaged in the inner threaded hole of the first screw rod. The second screw is provided with a support pad attached to a lower end thereof. The second screw rod is moveable relative to the first screw rod between an extended position and a retracted position. The gear driving means is adapted for driving the gear with the first and second screw rods to rotate such that the first screw rod is operable between the first and second position and the second screw rod is operable between the extended and retracted position.

When the first screw rod is in the first position and the second screw rod in the extended position, the frame assembly is capable of being raised and being self-supported on the ground by means of the support legs. When the first screw rod is in the second position and the second screw rod in the retracted position, the frame assembly is capable of being lowered adjacent to the ground.

Other objects, advantages and novel features of the invention will become more apparent from the following detailed description when taken in conjunction with the accompanying drawings.

### BRIEF DESCRIPTION OF THE DRAWINGS

FIG. 1 is a schematic side view of a conventional truck comprising a tractor and a trailer with a cargo container carried thereon.

FIG. 2 is a schematic isometric view of the truck of FIG. 1 without showing the container.

FIG. 3A is a schematic isometric view of a truck comprising a trailer for mounting a detachable platform of the present invention.

FIG. 3B is a schematic top view of a chassis frame of the trailer of FIG. 3A.

FIG. 4 is a fragmentary isometric view showing a cutout of a longitudinal frame member of the trailer of FIG. 3B.

FIG. 5 is a schematic isometric view of a detachable platform in accordance with a first embodiment of the present invention.

FIG. 6 is a fragmentary schematic view showing two longitudinal structural beams of the detachable platform of FIG. 5 having a plurality of recessed mating portions for vertical alignment and engagement with a plurality of hydraulic pistons arranged on the chassis frame of the trailer.

FIG. 7 is a schematic isometric view showing a modified detachable platform comprising two separated units of the present invention.

FIG. 7 is a schematic isometric view showing a modified detachable platform comprising two separated units of the present invention.

FIG. 8 is a schematic isometric view showing a detachable platform adapted for light transportation in accordance with the present invention.

FIG. 9 is a schematic isometric view showing a detachable platform adapted for heavy transportation in accordance with the present invention.

FIG. 10A is a fragmentary schematic isometric view showing a transverse channel member mounted on the longitudinal structural beams of the detachable platform in accordance with the present invention.

FIG. 10B is similar to FIG. 10A, but viewed from another aspect.

FIG. 11A is similar to FIG. 10A, showing another embodiment of the transverse channel member.

FIG. 11B is similar to FIG. 1A, but viewed from another aspect.

FIG. 12 is a fragmentary schematic isometric view showing a support leg of the detachable platform in accordance with the first embodiment of the present invention.

FIG. 13 is a schematic fragmentary isometric view showing a support leg of the detachable platform in accordance with a second embodiment of the present invention.

FIG. 14 is a schematic isometric view showing a transverse channel member of the detachable platform in accordance with the second embodiment of the present invention.

FIG. 15A is a schematic fragmentary isometric view showing a moveable member and a support leg operated in a vertical orientation.

FIG. 15B is similar to FIG. 15A, but the support leg is rotated relative to the transverse channel member and operated in a horizontal orientation.

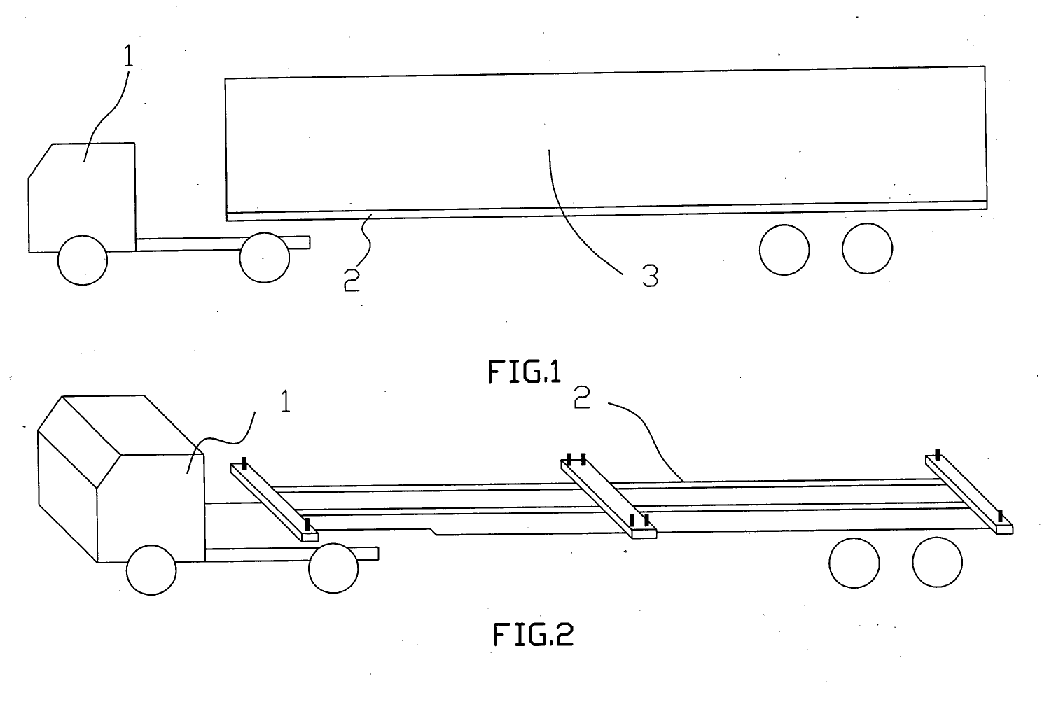

### DETAILED DESCRIPTION OF THE PREFERRED EMBODIMENT

Reference will now be made to the drawings to describe the embodiments of the present invention in detail.

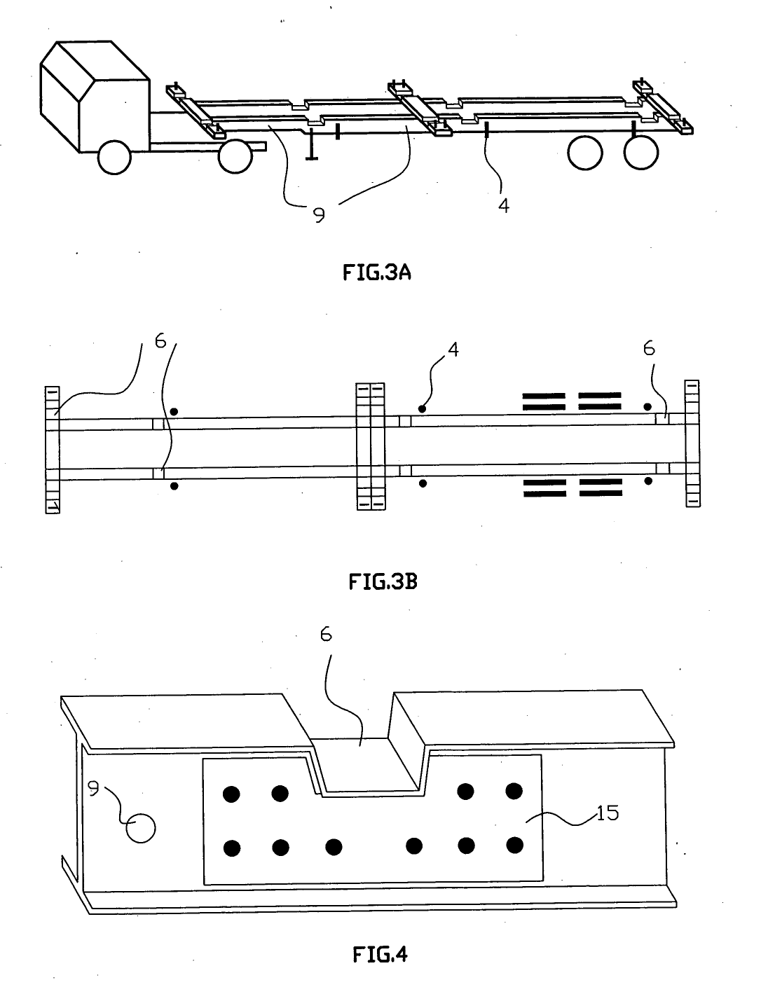

Referring initially to FIGS. 3A and 3B, an exemplary truck for mounting a detachable platform of the present invention comprising a tractor and a trailer coupled to the tractor. The trailer comprises a chassis frame including two parallel longitudinal frame members, and a plurality of transverse support members mounted to the longitudinal frame members. The chassis frame is preferably provided with a plurality of hydraulic jack pumps symmetrically mounted on the longitudinal frame members, adapted for raising the detachable platform and a container carried thereon off the chassis frame. Each hydraulic jack pump generally includes a hydraulic cylinder and a hydraulic piston 4. The hydraulic cylinder is connected to an oil pump and an oil tank via hydraulic pipes. The hydraulic jack pump is generally controlled by a controlling mechanism, which is known to those of ordinary skill in the art and will not be described in detail. It should be noted that the detachable platform may be also raised by lifting mechanisms of the detachable platform without using the hydraulic jack pump, which will be explained in detail below.

The transverse support members define first cutouts 6a therein for receivingly retaining portions of longitudinal structural beams of the detachable platform. The longitudinal frame members define second cutouts 6b therein for receivingly retaining portions of transverse channel members of the detachable platform. Referring to FIG. 4, the cutouts 6b section of the longitudinal frame members are preferably reinforced by two reinforcement panels 15 that are fastened by rivets thereto. The configuration of first and second cutouts 6a and 6b can effectively lower the overall profile of the detachable platform and the container for preventing rollovers. A plurality of pinholes 9 is defined in opposite sides of the longitudinal frame members for receiving locking pins thereby securing the detachable platform to the chassis frame.

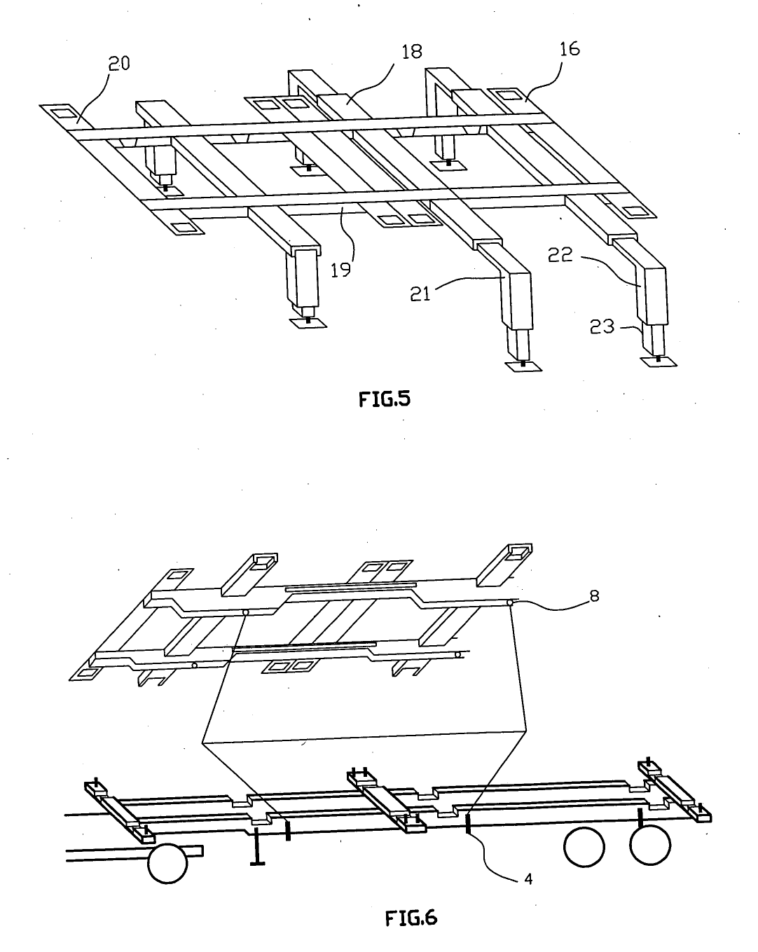

Referring to FIG. 5, the detachable platform for supporting the container in accordance with a first embodiment of the present invention is depicted. The detachable platform is for detachably mounting on the chassis frame of the trailer. The detachable platform comprises a substantially flat frame assembly having two longitudinal structural beams 19, and at least two support assemblies spacedly mounted on the frame assembly for supporting the frame assembly and the container. Referring to FIG. 6, a plurality of recessed mating portions 8 is formed on the undersides of the longitudinal structural beams 19, for vertical alignment and engagement with the hydraulic pistons 4. The detachable platform further comprises locking means 16 arranged at each corner of the frame assembly for interlocking the container to the chassis frame of the trailer.

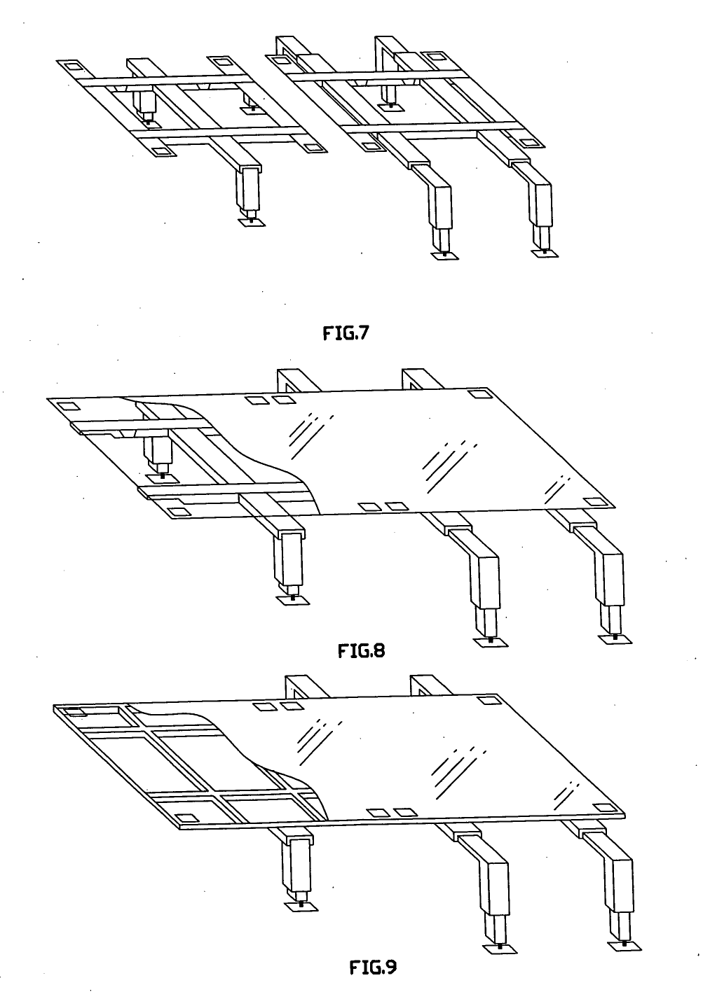

FIG. 7 shows a modified detachable platform. The detachable platform is a combination of two separated units for respectively supporting two containers. The platform units are both capable of being independently self-supported and are generally coupled to each other by bolting fishplates. Thus, the platform units with the containers supported thereon, if necessary, may be separately placed at two different locations. FIG. 8 illustrates a detachable platform adapted for light transportation provided with a load-supporting plate disposed on the longitudinal structural beams 19. FIG. 9 illustrates a detachable platform adapted for heavy transportation provided with additional transverse support beams mounted to the longitudinal structural beams 19 and particularly where such beams are necessary to support the container or to strengthen the frame assembly.

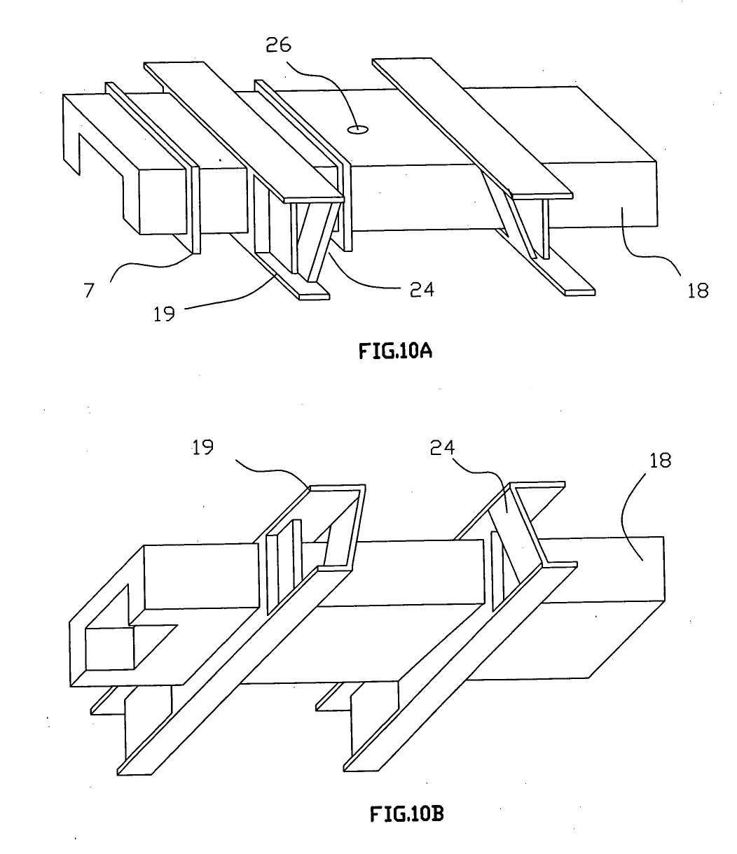

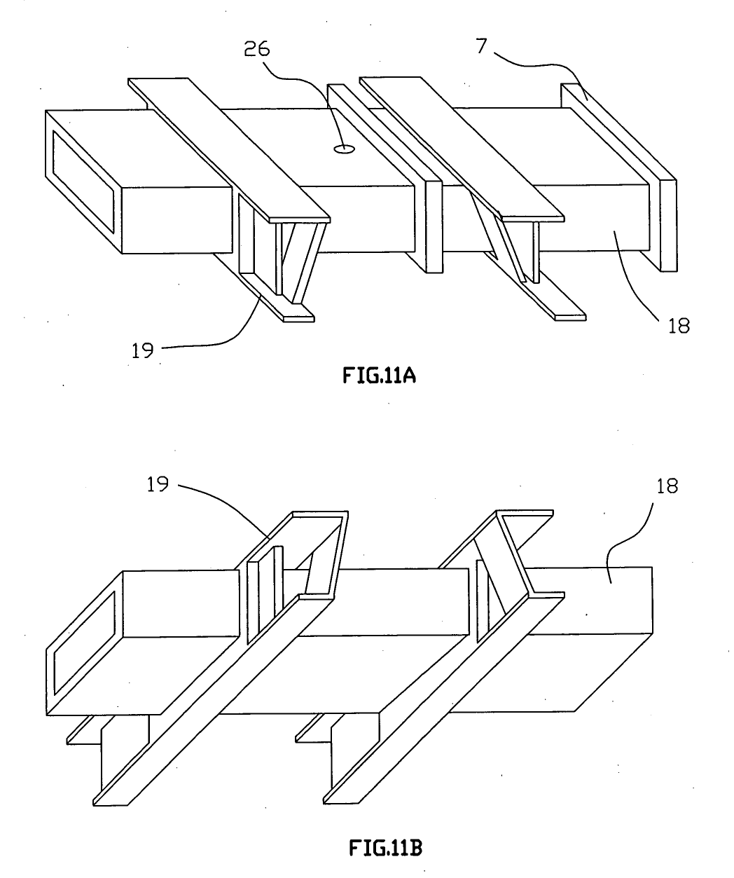

Referring back to FIG. 5, each support assembly comprises a transverse channel member 18 securely mounted to the longitudinal structural beams 19, two horizontal moveable members 21 and two support legs attached to the horizontal moveable members 21. Referring to FIGS. 10A-11B, the transverse channel member 18 is generally a square steel tube. Alternatively, the transverse channel member 18 may be a round steel tube. The horizontal moveable members 21 are slidably received in opposite ends of the transverse channel member 18 and are moveable between a retracted position and an extended position whereat the trailer is allowed to pass between support legs under the frame assembly. Preferably, the transverse channel members 18 define at least one air hole 26 for facilitating movement of the horizontal moveable member 21 received therein. Understandably, in the case of the round steel tube, the horizontal moveable members 21 are rotatable relative to the transverse channel member 18 which will be described in detail below.

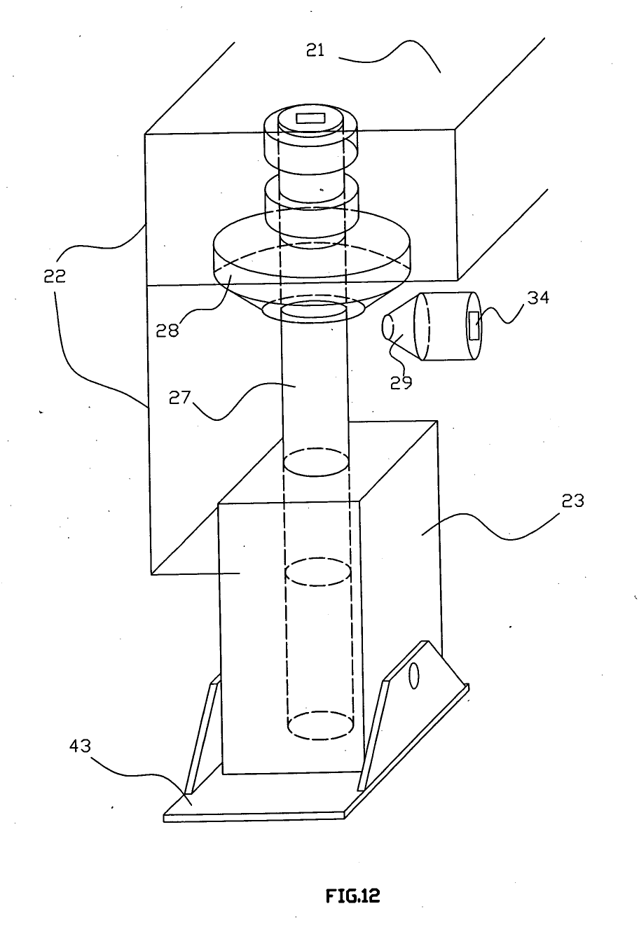

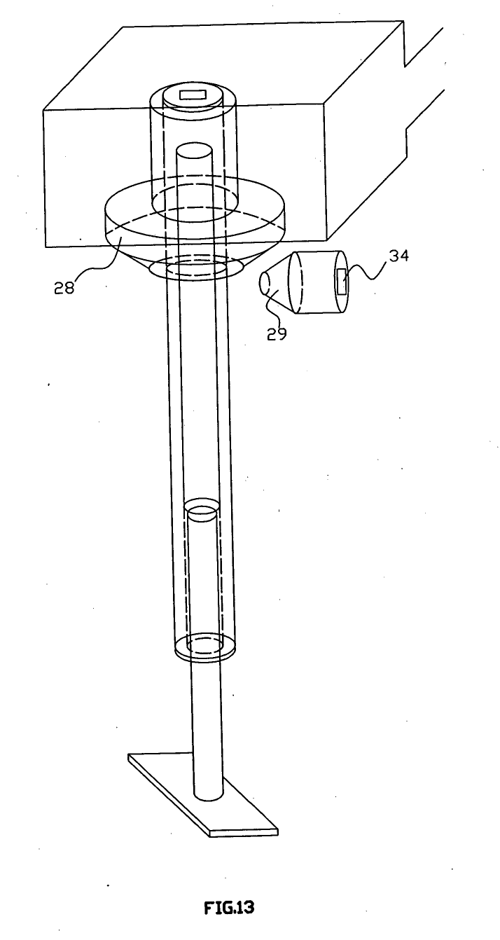

Referring to FIG. 12, each support leg comprises a screw rod 27 having a non-threaded portion and a threaded portion, a gear 28 coaxially fixedly secured to the screw rod 27, an upper portion 22 rotatably engaged with the non-threaded portion of the screw rod 27, a lower portion 23 threadedly engaged with the threaded portion of the screw rod 27, and gear driving means 29 for driving the gear 28 and the screw rod 27 to rotate. A slot is formed in the non-threaded portion of the screw rod 27 for engagement with a first handle adapted for driving the screw rod 27 to rotate without using the gear driving means 29. The upper portion 22 of the support leg is generally attached to opposite sides of the transverse channel member 21 shown in FIGS. 10A and 10B. Alternatively, The upper portion 22 of the support leg may be attached to a lower portion of opposite ends of the transverse channel member 21 shown in FIGS. 11A and 11B. The non-threaded portion of the screw rod 27 may be fixedly mounted to the horizontal moveable member 21 via a bearing, a plurality of rings or a plurality of bearing balls. In the present embodiment, the gear driving means 29 is a pinion formed with a slot for engagement with a second handle (not shown). Alternatively, the gear driving means 29 may be a screw rod, or a motor gear or other suitable conventional means. The gear driving means 29, the gear 28 and the screw rod 27 cooperatively constitute a lifting mechanism for raising the detachable frame.

In operation of the lifting mechanism, when detaching the detachable platform from the chassis frame of the trailer, the detachable platform is first raised off the chassis frame of the trailer to a raised position by means of the hydraulic jack pumps. Each horizontal moveable member 21 is extended outwardly, for instance, at a distance of 40 cm, to the extended position to allow the trailer to pass between the support legs. Each gear driving means 29, i.e. the pinions, are operated with the second handle to drive the gears 28 and the screw rods 27 to rotate. The lower portions 23 are then driven by the screw rods 27 to move downwardly to an extended position whereat the support legs reach the ground, and the detachable platform and the container are raised off the chassis frame of the trailer. Thereafter, the hydraulic pistons 4 are retracted to its original position, and the detachable platform and the container are self-supported on the ground by the support legs. It should be noted that, without the aids of the hydraulic jack pumps, the detachable frame is also capable of being raised off the chassis frame of the trailer only by means of the gear driving means. When attaching the detachable platform and the container thereon to the chassis frame of the trailer, the hydraulic pistons 4 are extended upwardly to support the detachable platform. The lower portions 23 are then driven by the screw rods 27 that are operated by the first handle to move upwardly to an retracted position whereat the detachable platform and the container are supported by wheels of the trailer, and the trailer is then ready to move again. A support pad 43 may be permanently attached to the lower portion 23 of the support leg or may be a separate unit. The support pad 43 has generally a large area for spreading the load. Alternatively, the support pad 43 may be further provided with at least one roller for allow the attachable platform with the container carried thereon is moveable, when it is self-supported.

In assembly, the detachable platform is placed onto the chassis frame of the trailer. The transverse channel members 18 of the detachable platform are retainably received in the second cutouts 6b of the longitudinal frame members of the trailer. The longitudinal structural beams 19 of the detachable platform are retainably received in the first cutouts 6a of the transverse support members of the trailer. The detachable platform is locked to the chassis frame by inserting the locking pins in the pinholes 9 of the chassis frame of the trailer. A container or other cargo unit is placed onto the detachable platform and is locked to the chassis frame by the locking means 16. The horizontal moveable member 21 and the support leg are initially in the retracted position, respectively. The trailer may then be used to move the container and the detachable platform to wherever is desired. When it reaches its destination, the hydraulic jack pump is operated to raise the detachable platform and the container off the chassis frame of the trailer. The support legs are then extended and lowered. The hydraulic jack pump is reversed so that the detachable platform is completely detached from the trailer and is self-supported by the support legs. The trailer then no longer supports the detachable platform and the container. The trailer can then be driven out from between the support legs leaving the container sitting on the detachable platform which is in turn supported by the support legs.

FIG. 13 illustrates a support leg of the detachable platform in accordance with a second embodiment of the present invention, and corresponding parts are indicated by the same reference numerals, as the case may be provided primarily to indicate a difference in configuration or structure. The most structure of the detachable platform of the second embodiment is similar to the detachable platform of the first embodiment. The detachable platform of the second embodiment comprises a substantially flat frame assembly having two longitudinal structural beams, and at least two support assemblies spacedly mounted on the frame assembly for supporting the frame assembly. Each support assembly comprises a transverse channel member mounted to the longitudinal beams, two horizontal moveable members 21 movably engaged in opposite ends of the transverse channel member between a retracted position and an extended position whereat the trailer is allowed to pass between support legs under the frame assembly, and two support legs attached to the horizontal moveable members 21.

However, each support leg of the second embodiment comprises an upper portion having a rotatable member 30 with a gear 28 fixed to the rotatable member 30 and an inner threaded hole defined in the rotatable member 30, a first screw rod 27a having an inner threaded hole defined therein and an outer thread in an outer surface thereof, a second screw rod 27b threadedly engaged in the inner threaded hole of the first screw rod 27a, and gear driving means 29.

The rotatable member 30 is rotatable relative to the upper portion of the support leg, but is unmovable relative to the horizontal moveable member 21. The first screw rod 27a is threadedly engaged in the inner threaded hole of the rotatable member 30 and is moveable relative to the rotatable member 30 between a first position whereat the horizontal moveable member is located adjacent to an upper end of the first screw rod 27a and a second position whereat the horizontal moveable member is located adjacent to a lower end of the first screw rod 27a. A slot is formed in a top end of the first screw rod 27a, for engagement with a first handle. The first screw rod 27a is driven by the first handle to rotate relative to the moveable member. The second screw rod 27b comprises a support pad 43 attached to a lower end thereof. The second screw rod 27b is moveable relative to the first screw rod 27a between an extended position and a retracted position. The gear driving means 28 is generally a pinion formed with a slot 34 for engagement a second handle for driving the gear 28 with the first and second screw rods 27a, 27b to rotate such that the first screw rod 27a is operable between the first and second position and the second screw rod 27b is operable between the extended and retracted position.

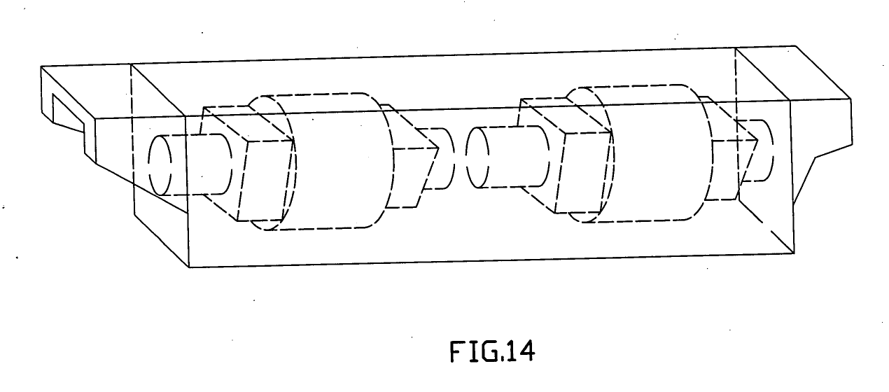

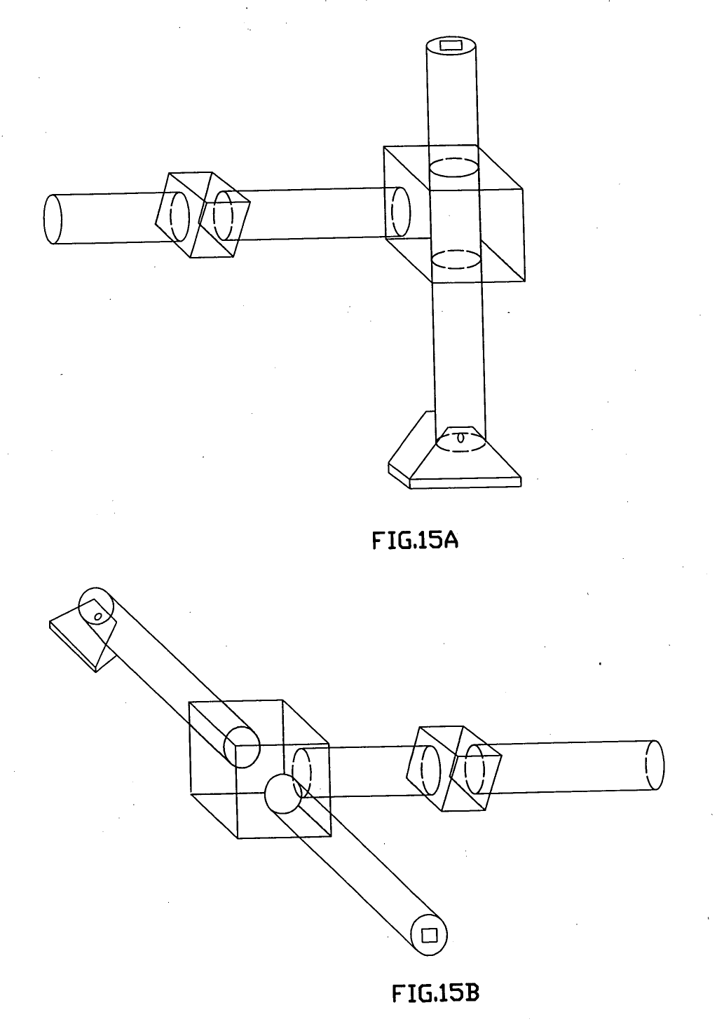

Referring to FIGS. 14 through 15B, the horizontal moveable member of the second embodiment is generally an axle with a square block formed in a middle of the axle. Correspondingly, the transverse channel member 21 defines an inner channel therein for moveably rotatably receiving the horizontal moveable member therein. The inner channel includes axle-receiving sections, first and second block-retaining sections and a block-receiving section. The axle-receiving sections are shaped corresponding the axle for moveably receiving the axle portion of the moveable therein. The first block-retaining section is shaped corresponding to the square block for retaining the square block in position when the moveable member is in an extended position and preventing the moveable member from rotating relative to the transverse channel member. The second block-retaining section is similar to the first block-retaining section. The second block-retaining section is for retaining the square block in position when the moveable member is in a retracted position. The block-receiving section is a cylindrical channel located between the first and second block-retaining sections, adapted for allowing the square block to freely rotate and slide therein. For instance, referring to FIG. 15A, when the moveable member is extended and oriented in a vertical orientation, the square block is retainably received in the second block-retaining section of the transverse channel member. Referring to FIG. 15B, the support leg can be retracted and changed into a horizontal orientation by manual retracting and rotating operation. In the present embodiment, the gear driving means 29, the gear 28, the first and second screw rods 27a and 27b cooperatively for a lifting mechanism for raising the detachable platform.

In operation of the lifting mechanism, when detaching the detachable platform of the second embodiment from the chassis frame of the trailer, the detachable platform is first raised off the chassis frame of the trailer to a raised position by means of the hydraulic jack pumps. Each horizontal moveable member is extended outwardly, for instance at a distance of 40 cm, to the extended position to allow the trailer to pass between the support legs. Each horizontal moveable member 21 is rotated from an original horizontal orientation to the vertical orientation. The first screw rod 27a is driven by the first handle to rotate with the support pad being stepped for preventing the second screw rod 27b from rotating so as to extend the second screw rod 27b downwardly toward the ground to the extended position. Each gear driving means 29, i.e. the pinions, are then operated with the second handle to drive the gears 28 and the first screw rods 27a to move to the first position. Thereafter, the hydraulic pistons are retracted. The detachable platform and the container are then self-supported on the ground by the support legs. However, it should be noted that, without the aids of the hydraulic jack pumps, the detachable frame is also capable of being raised off the chassis frame of the trailer only by means of the gear driving means 29. When attaching the detachable platform and the container thereon to the chassis frame of the trailer, the hydraulic pistons are extended upwardly to support the detachable platform. The second screw rod 27b is then driven by the gear driving means that are operated by the second handle to move upwardly to the retracted position whereat the detachable platform and the container are supported by wheels of the trailer, and the trailer is ready to move again. Advantageously, when the first screw rod 27a is rotatingly moved to the second position and the second screw rod 27b is moved to the retracted position, the frame assembly is capable of being lowered adjacent to the ground.

While the preferred embodiment in accordance with the present invention has been shown and described, equivalent modifications and changes known to persons skilled in the art according to the spirit of the present invention are considered to be within the scope of the present invention as defined in the appended claims.

1. A detachable platform for supporting a container, the platform being adapted for detachable mounting in a trailer, the platform comprising:
a frame assembly having at least two longitudinal beams; and
at least two support assemblies spacedly mounted on the frame assembly for supporting the frame assembly, each support assembly comprising a transverse channel member secured to the longitudinal beams, two horizontal moveable members movably engaged in opposite ends of the transverse channel member and moveable between a retracted position whereat the moveable members are substantially received in the transverse channel member and an extended position whereat the trailer is allowed to pass between support legs, and two support legs attached to the horizontal moveable members, each support leg comprising
a screw rod having a non-threaded portion and a threaded portion,
a gear coaxially fixedly secured to the screw rod,
an upper portion rotatably engaged with the non-threaded portion of the screw rod,
a lower portion with a support pad at the base thereof threadedly engaged with the threaded portion of the screw rod, the lower portion being reciprocally moveable relative to the upper portion between a first extended position whereat the frame assembly is capable of being raised and being self-supported on the ground by means of the support legs, and a second retracted position whereat the frame assembly is capable of being supported by wheels of the trailer, and
gear driving means for driving the gear and the screw rod to rotate such that the lower portion is operable between the first and second position.

2. The detachable platform as described in claim 1, wherein the gear driving means is a pinion, a screw rod, or a motor gear.

3. The detachable platform as described in claim 1, wherein the transverse channel member is a square steel tube.

4. The detachable platform as described in claim 1, wherein the transverse channel member is a round steel tube.

5. The detachable platform as described in claim 4, wherein the horizontal moveable members are rotatable relative to the transverse channel member.

6. The detachable platform as described in claim 1, wherein the trailer comprises hydraulic jack pumps for raising the frame assembly of the detachable platform.

7. The detachable platform as described in claim 1, wherein the transverse channel members define at least one air hole therein for facilitating movement of the horizontal moveable member received therein.

8. The detachable platform as described in claim 1, wherein the non-threaded portion of the screw rod is fixedly mounted to the horizontal moveable member via a bearing, a plurality of rings or a plurality of bearing balls.

9. The detachable platform as described in claim 1, wherein the non-threaded portion of the screw rod comprising a handle adapted for operatively rotating the screw rod without using the gear driving means.

10. The detachable platform as described in claim 1, wherein the support pad comprising at least one roller.

11. A detachable platform for supporting a container, the platform being adapted for detachable mounting in a trailer, the platform comprising:
a flat frame assembly having at least two longitudinal beams; and
at least two support assemblies spacedly mounted on the frame assembly for supporting the frame assembly, each support assembly comprising a transverse channel member mounted to the longitudinal beams, two horizontal moveable members movably engaged in opposite ends of the transverse channel member and moveable between a retracted position and an extended position whereat the trailer is allowed to pass between support legs, and two support legs attached to the horizontal moveable members, each support leg comprising
an upper portion comprising a rotatable member having a gear fixedly to the rotatable member and an inner threaded hole defined in the rotatable member, the rotatable member being rotatable relative to the upper portion, a first screw rod having an inner threaded hole defined therein and an outer thread, the first screw rod being threadedly engaged in the inner threaded hole of the rotatable member and being moveable relative to the rotatable member between a first position whereat the horizontal moveable member is located adjacent to an upper end of the first screw rod and a second position whereat the horizontal moveable member is located adjacent to a lower end of the first screw rod,
a second screw rod threadedly engaged in the inner threaded hole of the first screw rod, the second screw having a support pad attached to a lower end thereof, the second screw rod being moveable relative to the first screw rod between an extended position and a retracted position, and
gear driving means for driving the gear with the first and second screw rods to rotate such that the first screw rod is operable between the first and second position and the second screw rod is operable between the extended and retracted position; whereby
when the first screw rod is in the first position and the second screw rod in the extended position, the frame assembly is capable of being raised and being self-supported on the ground by means of the support legs;
when the first screw rod is in the second position and the second screw rod in the retracted position, the frame assembly is capable of being lowered adjacent to the ground.

12. The detachable platform as described in claim 11, wherein the gear driving means is a pinion, a screw rod, or a motor gear.

13. The detachable platform as described in claim 11, wherein the transverse channel member is a square steel tube.

14. The detachable platform as described in claim 11, wherein the transverse channel member is a round steel tube.

15. The detachable platform as described in claim 14, wherein the horizontal moveable members are rotatable relative to the transverse channel member.

16. The detachable platform as described in claim 11, wherein the trailer comprises hydraulic jack pumps for raising the frame assembly of the detachable platform.

17. The detachable platform as described in claim 11, wherein the transverse channel members define at least one air hole for facilitating movement of the horizontal moveable member received therein.

18. The detachable platform as described in claim 11, wherein the rotatable member is fixedly mounted to the horizontal moveable member via a bearing, a plurality of rings or a plurality of bearing balls.

19. The detachable platform as described in claim 11, wherein an upper portion of the first screw rod comprising a handle adapted for operatively rotating the first and second screw rods without using the gear driving means.

20. The detachable platform as described in claim 1, wherein the support pad comprising at least one roller.
